(19) United States
(12) Patent Application Publication
(10) Pub. No.: US 2026/0285475 A1
(43) Pub. Date: Sep. 24, 2026

(54) FAN ROTOR WITH ACTUATOR WITH LOCKING DEVICE

(71) Applicant: SAFRAN AIRCRAFT ENGINES, Paris (FR)

(72) Inventors: Jacques AURIOL, MOISSY-CRAMAYEL (FR); Jean Charles Olivier RODA, MOISSY-CRAMAYEL (FR)

(21) Appl. No.: 19/471,565

(22) PCT Filed: Apr. 4, 2024
(86) PCT No.: PCT/FR2024/050441

§ 371 Date: Oct. 1, 2025

(30) Foreign Application Priority Data
Apr. 6, 2023 (FR) FR 2303469

(51) Int. Cl. B64C 11/40; F01D 7/00

(52) U.S. Cl. CPC B64C 11/40; F01D 7/00; F05D 2260/30; F05D 2260/70

(57) ABSTRACT

A fan rotor includes an actuator with an actuating cylinder and a locking device that immobilize a movable portion of the actuating cylinder. The locking device includes a notched surface, a blocking member having an unlocked configuration spaced apart from the notched surface and a locked configuration engaged with the notched surface, a movable member that is movable between a retracted position in which the movable member leaves the blocking member free to be in its unlocked configuration and a deployed position in which the moveable member forces the blocking member into its locked configuration, a return member that urges the movable member towards its deployed position and a holding device that holds the movable member in its retracted position.

### FIELD OF THE INVENTION

The present invention concerns the general field of actuators comprising a jack and a device for locking the movable part of the jack. It more specifically concerns the field of actuators for controlling the orientation of variable-setting blades such as those equipping the fans of some turbomachines.

One preferred field of application of the invention is that of the turbojet engines with unducted fan (better known as propfan, open fan, open rotor and unducted fan). However, the invention also applies to turboprop engines with one or more pusher propellers.

### TECHNOLOGICAL BACKGROUND

One of the avenues currently being explored to improve the specific fuel consumption of civil airplane engines is the development of unducted fan turbojet engines, such as the one described in document FR 2 941 493. These turbojet engines include a conventional turbine engine gas generator, one or more turbine stages of which drive one or more unducted fans extending outside the nacelle of the engine.

The blades of this or these fan(s) are, as in the case of conventional turboprop engines, variable-setting blades, that is to say the angular position of these blades (called setting angle) can be modified during flight. As a reminder, the setting angle of a blade corresponds to the angle, in a plane orthogonal to the pivot axis of the blade, between the axis of rotation of the fan and the chord of the blade at 75% of the radius of the fan. It can vary from a value equal to 90°, corresponding to a position called “web” or “flat” position of the blade, to a value equal to 0°, corresponding to a position called “feather” position of the blade. It can also take a value strictly greater than 90°, typically substantially equal to 95°, corresponding to a position called “reverse” position of the blade.

As is well known, this modification of the setting angle during flight allows changing the engine thrust and optimizing the fan efficiency as a function of the speed of the aircraft. Indeed, the rpm of the fans is almost constant throughout all the operating phases, and it is the setting of the blades that varies the thrust. Thus, during cruise flight phase, the blades are oriented so as to adjust the thrust by minimizing the power drawn from the turbine shaft and the consumption, and by optimizing the efficiency. Conversely, during takeoff, the blades are oriented so as to maximize the thrust in order to accelerate and then take off the airplane.

The steering of the orientation of the blades is commonly carried out using a pitch change mechanism comprising a control jack including a movable part in translation along the axis of the fan and a connection system connecting the movable part to the blade so as to convert the translation of the movable part into a rotation of the variable-setting blade.

A difficulty encountered with the variable-setting blades is that, in the event of a malfunction of the systems steering their orientation, said blades tend, under their own centrifugal effect, to assume the web position. However, a blade blocked in this position generates little resistive torque and risks causing the engine to overspeed, with potential engine damage risks. Moreover, a blade blocked in this position also risks generating excessive drag that is unacceptable for the controllability and/or range of the airplane in the event of a diversionary mission.

To overcome this difficulty, it is known to use safety systems able to oppose the movement of variable-setting blades toward the small pitches (that is to say toward the web position) in the event of a failure of the blade orientation control system. Such a system is for example known from EP 3 400 169.

A safety system integrating a ball screw-type screw-and-nut system coupled to a locking nut into the jack controlling the orientation of the blades is known. During normal operation, the nut of the screw-and-nut system follows the movements of the control jack, thus causing the rotation of the screw about its axis, while the locking nut follows the screw thread without ever touching it (the tapping of the locking nut is designed so as to provide slight clearance with the screw thread). In the event of a malfunction of the blade orientation control system, the screw of the screw-and-nut system is immobilized (its rotation is blocked) and the locking nut meshes with said screw, thus preventing the pivoting of the blades toward the small pitches.

This safety system is however not entirely satisfactory. Indeed, for a proper operation, it requires an accurate and a complex management of the clearances between the locking nut and the screw thread.

### DISCLOSURE OF THE INVENTION

One objective of the invention is to allow, in a simple and robust manner, the locking of a jack in at least one direction. Other objectives are to allow the locking of the jack in its current position (within a certain tolerance), to allow the locking in the absence of supply energy of the jack, to allow the locking and/or unlocking with a low force, to allow a locking that withstands the very high loads and to limit the bulk of the locking mechanism.

For this purpose, the invention relates, according to a first aspect, to an actuator comprising:
a control jack including a fixed part and a movable part movable in translation along a longitudinal axis relative to the fixed part, and
a locking device capable of blocking the translation of the movable part relative to the fixed part in at least one direction,
   in which the locking device comprises:
a surface secured to the fixed part or movable together with the movable part relative to the fixed part, the surface being notched with a plurality of notches each extending orthogonally to the longitudinal axis,
a blocking member having an unlocking configuration away from the surface and a locking configuration meshed with the surface so that the movable part is immobilized in translation relative to the fixed part, in which the blocking member is engaged in at least one of said notches,
a movable member movable in translation relative to the blocking member between a retracted position in which it leaves the blocking member free to be in its unlocking configuration and a deployed position in which it forces the blocking member into its locking configuration,
a biasing member biasing the movable member towards its deployed position, and
a holding device for holding the movable member in its retracted position under certain predetermined conditions.

According to particular embodiments of the invention, the actuator also has one or more of the following characteristics, taken separately or in any technically possible combination(s):
the predetermined conditions consist of a supply pressure to the chambers of the control jack above a threshold;
said threshold is smaller than a minimum supply pressure to the chambers of the control jack under normal operating conditions;
the holding device comprises a counterbalancing jack with a counterbalancing chamber in contact with a piston secured to the movable member, able to receive a pressurized fluid to counterbalance the biasing of the biasing device;
the surface is movable together with the movable part relative to the fixed part and is preferably secured to the movable part, the blocking member being substantially fixed along the longitudinal axis relative to the fixed part;
the surface comprises, for each pair of consecutive notches, a rib separating said notches, said rib having inclined flanks, said flanks having a maximum inclination preferably less than 88°, particularly less than 60°, for example less than 45°;
the rib has a rounded top;
each notch has a rounded bottom, the transition from a rib top to a notch bottom, via a rib flank, occurring without any slope break;
the blocking member comprises at least one annulus disposed orthogonally to the longitudinal axis, said annulus being circumferentially divided into several sectors movable with respect to each other between a close configuration in which the annulus has a reduced diameter, and a spaced-apart configuration in which the annulus has an increased diameter, the blocking member being in the locking configuration when the annulus is in one of the spaced-apart and close configurations and in the unlocking configuration when the annulus is in the other of the spaced-apart and close configurations;
the or each annulus is, in the locking configuration, engaged in only one of the notches of the surface;
the or each annulus comprises a biasing element biasing the sectors towards the one of the spaced-apart and close configurations in which the blocking member is in the unlocking configuration;
each sector has a circular or ovoid section;
each sector has a polygonal section;
each sector comprises two flanks delimiting the sector along the longitudinal direction, said flanks converging towards each other in the direction of the surface;
the flanks are substantially symmetrical with respect to a plane orthogonal to the longitudinal axis and form together an angle comprised between 4°and 90°, particularly greater than 60°;
the blocking member has a first face oriented towards the surface and a second face opposite to the first face, and the movable member comprises a retaining face able to be in contact with the second face of the blocking member in the locking configuration;
the second face has a contact edge through which the movable member comes into contact with the blocking member when it moves from its retracted position to its deployed position, said contact edge being beveled;
the movable member has at least one contact face through which it comes into contact with the blocking member when it moves from its retracted position to its deployed position, said contact face being beveled and/or provided with at least one rolling;
for the or each contact face, at least one rolling is located at a junction between the contact face and the retaining face;
the movable member has a contact face for each annulus of the blocking member, said contact face forming a face through which the movable member comes into contact with said annulus when it moves from its retracted position to its deployed position;
the locking device comprises an elastic sheath between the surface and the fixed part, said elastic sheath isolating the surface from the environment;
the surface is interposed between the longitudinal axis and the blocking member; and
the surface is cylindrical and the blocking member extends around said surface.

The invention also relates, according to a second aspect, to a fan rotor for a turbomachine comprising a hub and a plurality of variable-setting blades each pivotable relative to the hub about a specific pivot axis, the rotor further comprising an actuator according to the first aspect for adjusting an angular position of each of the variable-setting blades about its respective pivot axis, the fixed part being fixed relative to the pivot axis, the actuator further comprising a connection system connecting the movable part to the variable-setting blade so as to convert the translation of the movable part along the longitudinal axis into a rotation of the variable-setting blade about the pivot axis.

According to one particular embodiment of the invention, the fan rotor also has the following characteristic:
the longitudinal axis constitutes an axis of rotation of the rotor.

The invention also relates, according to a third aspect, to a turbomachine comprising a fan rotor according to the second aspect.

According to one particular embodiment of the invention, the turbomachine also has the following characteristic:
the longitudinal axis constitutes an axis of elongation of the turbomachine.

Finally, the invention relates, according to a fourth aspect, to an aircraft comprising at least one turbomachine according to the third aspect.

### BRIEF DESCRIPTION OF THE FIGURES

Other characteristics and advantages of the invention will appear upon reading the following description given solely by way of example and made with reference to the appended drawings, in which:

FIG. 1 is a top view of an aircraft according to one exemplary embodiment of the invention,

FIG. 2 is a simplified longitudinal sectional view of a turbomachine of the aircraft of FIG. 1,

FIG. 3 is a simplified longitudinal sectional view of part of a pitch change mechanism of the turbomachine of FIG. 2,

FIG. 4 is a simplified view along a radial axis of an arm of rotation of a variable-setting blade of the turbomachine of FIG. 2,

FIG. 5 is a partial simplified longitudinal sectional view of a first variant of a locking device of the pitch change mechanism of FIG. 3, in a first configuration,

FIG. 6 is a view similar to that of FIG. 5, the locking device being in a second configuration,

FIGS. 7 and 8 are partial simplified longitudinal sectional views of other variants of the locking device of the pitch change mechanism of FIG. 3, and

FIGS. 9 and 10 are front views of a blocking member of the locking device of FIGS. 5 and 6.

### DETAILED DESCRIPTION OF ONE EXEMPLARY EMBODIMENT

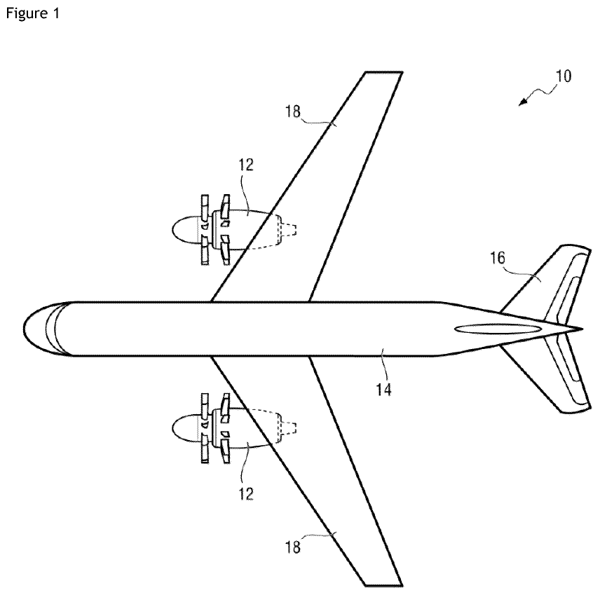

The aircraft 10 represented in FIG. 1 comprises turbomachines 12 to propel it.

In the example represented, the aircraft 10 is an airplane. It conventionally comprises a fuselage 14, an empennage 16 and two wings 18. There are two turbomachines here, each housed under a respective wing 18. As a variant (not represented), the turbomachines 12 are disposed along the fuselage 14, for example in the vicinity of the empennage 16. Still as a variant (also not represented), the aircraft 10 comprises a single turbomachine 12 or at least three turbomachines 12.

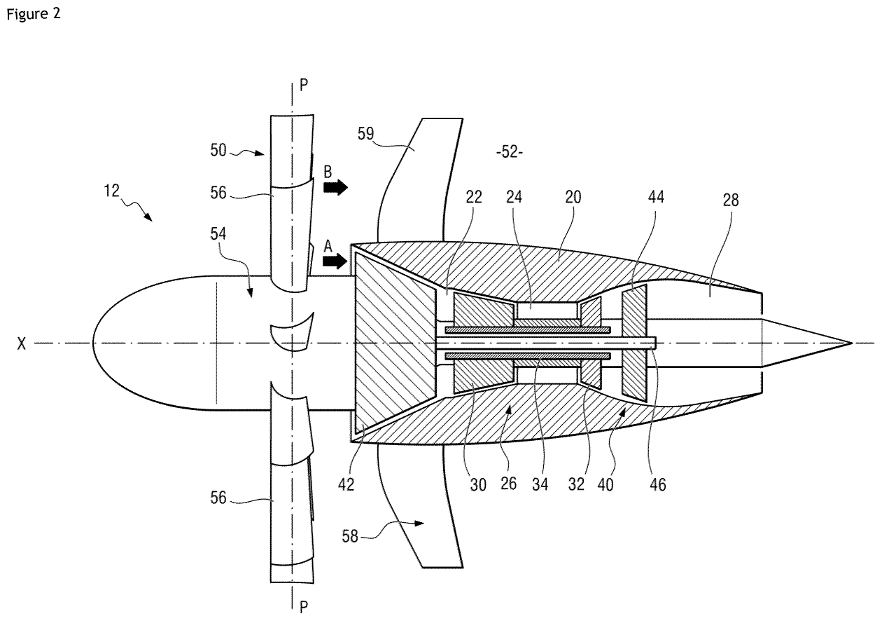

One of the turbomachines 12 is represented in FIG. 2.

As can be seen in this FIG. 2, the turbomachine 12 is elongated along a longitudinal axis X. It typically has angular symmetry about said longitudinal axis X, that is to say there is at least one angle for which the turbomachine is invariant by rotation about the longitudinal axis X.

Here and hereinafter, the terms “internal” and “external”, “inner” and “outer”, as well as their variations, are understood with reference to the axis X, an element described as “internal” or “inner” being oriented towards the axis X while an “external” or “outer” element is oriented opposite to the axis X.

The turbomachine 12 conventionally comprises a nacelle 20, an inner flowpath 22 for circulating an air stream through the nacelle 20, a combustion chamber 24 housed in the flowpath 22, an engine spool 26 and a gas exhaust nozzle 28.

In the following, the terms “upstream” and “downstream” are understood with reference to a direction of flow of an air stream through the flowpath 22.

The engine spool 26 comprises a compressor 30, a turbine 32 and a transmission shaft 34 coupling the turbine 32 to the compressor 30 for the driving of the compressor 30 by the turbine 32. The compressor 30 is disposed upstream of the combustion chamber 24 and supplies the combustion chamber 24 with compressed air. The turbine 32 is disposed downstream of the combustion chamber 24 and receives the exhaust gases exiting the combustion chamber 24.

The transmission shaft 34 has the longitudinal axis X as its axis of rotation.

The transmission shaft 34 is guided in rotation with respect to the nacelle 20 by means of bearings (not represented).

In the example represented, the turbomachine 12 is a multi-spool turbomachine, particularly a double-spool turbomachine, comprising a low-pressure spool 40 in addition to the engine spool 26. The engine spool 26 then constitutes a high-pressure spool, the compressor 30 being a high-pressure compressor, the turbine 32 being a high-pressure turbine and the transmission shaft 34 being a high-pressure shaft.

The low-pressure spool 40 comprises a low-pressure compressor 42, a low-pressure turbine 44 and a low-pressure shaft 46 coupling the low-pressure turbine 44 to the low-pressure compressor 42 for the driving of the low-pressure compressor 42 by the low-pressure turbine 44.

The low-pressure compressor 42 is disposed upstream of the high-pressure compressor 30 and supplies the latter with compressed air. The low-pressure turbine 44 is disposed downstream of the high-pressure turbine 32 and receives the exhaust gases exiting the latter.

The low-pressure shaft 46 is guided in rotation with respect to the nacelle 20 by means of bearings (not represented).

The low-pressure shaft 46 is coaxial with the high-pressure shaft 34. Its axis of rotation is therefore also the longitudinal axis X. Particularly, the low-pressure shaft 46 extends inside the high-pressure shaft 34.

The turbomachine 12 also comprises a fan 50 to drive the air stream in an outer circulation flowpath 52 surrounding the nacelle 20. A primary air stream A (hot) consisting of the portion of the air stream driven in the inner circulation flowpath 22 and a secondary air stream B (cold) consisting of the portion of the air stream driven in the outer circulation flowpath 52 are thus distinguished.

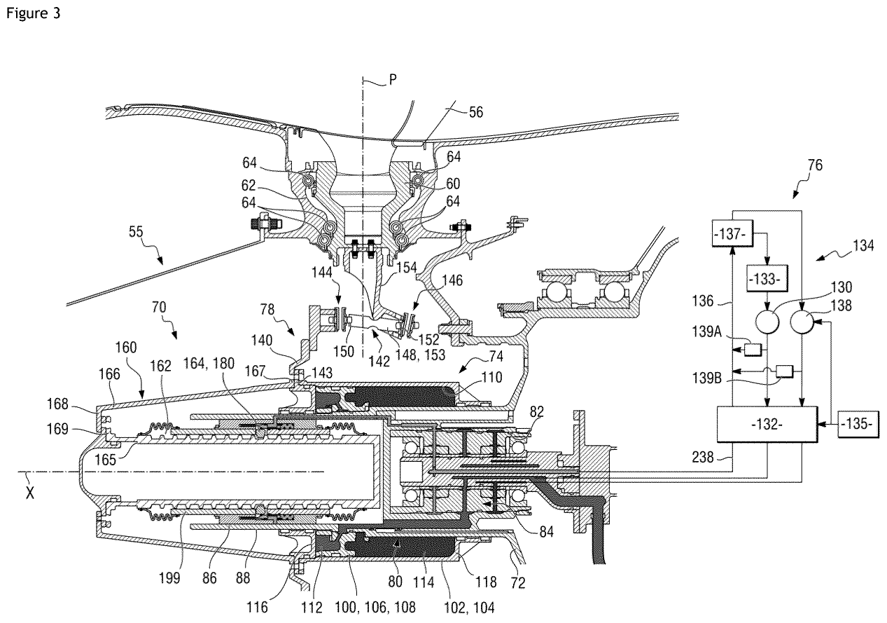

The fan 50 comprises a fan rotor 54. This fan rotor 54 is rotatably mounted relative to the nacelle 20 about the longitudinal axis X. It comprises a hub 55 (FIG. 3) provided with fan blades 56 extending substantially radially outward from the hub 55. These blades 56, when rotated, drive the air stream in the outer circulation flowpath 52.

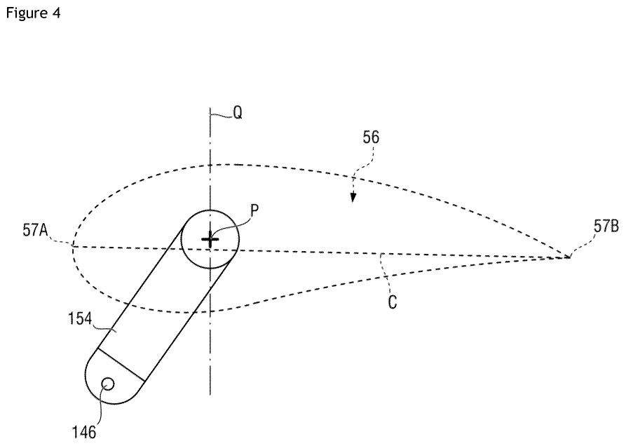

As can be seen in FIG. 4, each blade 56 comprises a leading edge 57A, a trailing edge 57B and a chord C connecting the leading edge 57A to the trailing edge 57B.

Returning to FIG. 2, the fan rotor 54 is driven in rotation by the low-pressure turbine 44, via the low-pressure shaft 46. This driving typically is done via a reduction gear allowing the fan rotor 54 to rotate at a speed lower than that of the low-pressure shaft 46. As a variant, this driving is direct, that is to say the fan rotor 54 is secured in rotation to the low-pressure shaft 46.

In the example represented, the fan 50 also comprises a fan stator 58 comprising vanes 59 arranged at the periphery of the nacelle 20, in the outer circulation flowpath 52, along a plane orthogonal to the longitudinal axis X. This fan stator 58 is here arranged downstream of the fan rotor 54. As a variant (not represented), the fan 50 comprises, instead of the fan stator 58, a counter-rotating fan rotor.

Advantageously, the fan 50 is, as represented, unducted, that is to say the outer circulation flowpath 52 has no peripheral delimitation. The turbomachine 12 is then constituted, as represented, by a turbojet engine with an unducted fan or, as a variant, by a turboprop engine. As a variant (not represented), the outer circulation flowpath 52 is defined between the nacelle 20 and a fan casing surrounding the fan 50; the turbomachine 12 is then typically constituted by a turbojet engine with a high bypass ratio, the bypass ratio being defined as the ratio of the flow rate of the secondary stream B (cold) to the flow rate of the primary stream A (hot).

In the example represented, the turbomachine 12 is particularly of the “puller” type, that is to say the fan 50 is disposed upstream of the inner circulation flowpath 22 and also drives the air stream in the latter. As a variant (not represented), the turbomachine is of the “pusher” type, that is to say the fan 50 is placed around the downstream half of the nacelle 20.

The blades 56 of the fan rotor 54 are variable-setting blades, that is to say each blade 56 is pivotally mounted relative to the hub 55 about its own pivot axis P. This pivot axis P extends along the direction of elongation of the blade 56. It is orthogonal to the longitudinal axis X.

Each blade 56 is particularly able to pivot about the axis P relative to the hub 55 between a position called feather position in which the chord C of the blade 56 is substantially parallel to the longitudinal axis X, and a position called web position in which the chord C of the blade 56 is substantially orthogonal to the longitudinal axis X. Preferably, each blade 56 is also able to pivot beyond the web position, to a position called reverse position in which the chord C of the blade 56 forms an angle strictly greater than 90°, for example substantially equal to 95°, with the longitudinal axis X. Since the blades 56 are most often twisted, the chord C taken as a reference for measuring the setting angle is, by convention, constituted by the chord of the blade at 75% of the radius of the fan rotor 54.

For this purpose, each blade 56 is secured, as seen in FIG. 3, to an attachment piece 60 disposed at the blade root. This attachment piece 60 is rotatably mounted with respect to the hub 55 about the pivot axis P. More specifically, the attachment piece 60 is rotatably mounted inside a housing 62 arranged in the hub 55 by means of balls 64 or other rolling elements.

The fan 50 further comprises a pitch change mechanism 70 for adjusting the setting angle of each blade 56 about its pivot axis P so as to adapt the performance of the turbomachine 12 to the different flight phases.

With reference to FIG. 3, this pitch change mechanism 70 comprises a frame 72, a control jack 74, a system 76 for steering the jack 74 and a connection system 78.

The frame 72 is secured to the hub 55 and is typically constituted by part of the hub 55. It is thus fixed relative to the pivot axes P.

The frame 72 comprises a base 80. This base 80 is centered on the longitudinal axis X. Here, it is crossed by the pivot axes P.

In the example represented, the base 80 delimits a housing 82 open downstream. This housing 82 is particularly cylindrical, typically cylindrical of revolution, and centered on the axis X. An oil transfer bearing 84 is received in said housing 82.

In the example represented, the frame 72 also comprises a cylinder 86 protruding upstream from the base 80. This cylinder 86 is centered on the axis X and open at its upstream end 88. It is typically cylindrical of revolution.

The base 80 and the peripheral cylinder 86 together delimit an outer peripheral surface 88 of the frame 72. This outer peripheral surface 88 is substantially cylindrical and centered on the axis X. It is oriented radially outward.

The control jack 74 includes a fixed part 100 secured to the frame 72, and a movable part 102 movable in translation along the longitudinal axis X relative to the fixed part 100 between a retracted position represented in FIG. 3, and a deployed position (not represented). Optionally, the movable part 102 is also movable in rotation about the longitudinal axis X over a narrow angle, for example of the order of 5°.

The control jack 74 particularly comprises a continuous cylinder 104, forming one of the fixed part 100 and of the movable part 102 and a piston 106 forming the other of the fixed part 100 and of the movable part 102. Here, the cylinder 104 forms the movable part 102 and the piston 106 forms the fixed part 100. As a variant (not represented), it is the opposite: the cylinder 104 forms the fixed part 100 and the piston 106 forms the movable part 102.

Thus, in the example represented, the cylinder 104 extends around the outer peripheral surface 88 of the frame 72, coaxially with the latter, and the piston 106 is constituted by a collar 108 secured to the frame 72 extending radially outwards from the outer peripheral surface 88 to the cylinder 104.

The cylinder 104 delimits an inner cavity 110. The piston 106 divides said inner cavity 110 into two contiguous fluid chambers 112, 114. Each one contains a control fluid, typically consisting of an oil, to control the movement of the movable part 102 relative to the fixed part 100. This control fluid is at a first pressure in the first fluid chamber 112 and at a second pressure in the second fluid chamber 114. The first and second fluid chambers 112, 114 are arranged such that the relative increase of the first pressure (that is to say relative to the second pressure) causes the piston 110 to move towards its deployed position, the relative increase of the second pressure (that is to say relative to the first pressure) causes the piston 110 to move towards its retracted position.

Here, each of the fluid chambers 112, 114 is delimited internally by the outer peripheral surface 88 of the frame 72 and externally by the cylinder 104. The first fluid chamber 112 is further delimited at its downstream end by the piston 106 and the second fluid chamber 114 is delimited at its upstream end by the piston 106.

The control jack 74 is thus particularly compact, which allows it to be lighter.

In the example represented in FIG. 3, the movable part 102 also comprises an upstream guide ring 116 and a downstream guide ring 118 each secured to the cylinder 104 and extending radially inward from the cylinder 104 to the outer peripheral face 88 of the frame 72. The upstream guide ring 116 is disposed upstream of the piston 106 and delimits an upstream end of the first fluid chamber 112. The downstream guide ring 118 is disposed downstream of the piston 106 and delimits a downstream end of the second fluid chamber 114.

In the example represented in FIG. 3, each of the upstream and downstream guide rings 116, 118 constitutes a sealing ring and longitudinally closes the first fluid chamber 112, respectively the second fluid chamber 114. The fluid chambers 112, 114 are thus closed to each of the longitudinal ends of the control jack 74.

As a variant (not represented), only the downstream guide ring 118 constitutes a sealing ring. The upstream guide ring 116 has drillings allowing the control fluid to flow through the upstream guide ring 116.

Still as a variant (not represented), the movable part 102 does not comprise an upstream guide ring 116.

The steering system 76 comprises a pressure generator 130 for bringing the control fluid to a third pressure higher than the first and second pressures, a pressure monitoring unit 132 for adjusting the pressure of the control fluid in the first and second fluid chambers 112, 114 using the third pressure, and a return line 136 for discharging the depressurized control fluid. The steering system 76 also comprises a main tank 133, a backup circuit 134 and a control module 135.

The pressure generator 130 comprises for example a pump able to pump the fluid to bring it to the third pressure, for example 100 bars. A main pressure relief valve 139A allows discharging part of the control fluid to the return line 136 when the pressure of the control fluid downstream of the pressure generator 130 exceeds the third pressure.

The pressure monitoring unit 132 is supplied with control fluid at the third pressure by the pressure generator 130. It is fluidly connected to the first fluid chamber 112 and to the second fluid chamber 114 via the oil transfer bearing 84. It is able to distribute the control fluid between the first fluid chamber 112 and the second fluid chamber 114 so as to adjust the fluid pressure inside each of these chambers 112, 114 and thus adjust the position of the piston 110 between its retracted and deployed positions. It is also able to discharge control fluid coming from the first and second fluid chambers 112, 114 into the return line 136.

The main tank 133 is configured to collect depressurized control fluid coming from the return line 136. It supplies the pressure generator 130.

The backup circuit 134 is able to supply the first fluid chamber 112 with control fluid so as to move the piston 110 to its deployed position in the event of a failure of the pressure generator 130. For this purpose, the backup circuit 134 comprises an auxiliary tank 137 and an auxiliary pump 138. In the example represented, it also comprises an auxiliary pressure relief valve 139B.

The auxiliary tank 137 is configured to collect depressurized control fluid coming from the return line 136. It supplies the auxiliary pump 138. In the example represented, it also supplies the main tank 133, the depressurized control fluid coming from the return line 136 passing through the auxiliary tank 137 before reaching the main tank 133.

The auxiliary pump 138 is able to pump the control fluid into the auxiliary tank 137 to bring it to the third pressure. It is fluidly connected to the pressure monitoring unit 132 so as to supply it with control fluid at the third pressure, the pressure monitoring unit 132 being configured to redirect the entire control fluid coming from the auxiliary pump 138 to the first fluid chamber 112.

The pressure relief valve 139B is able to discharge part of the control fluid to the return line 136 when the pressure of the control fluid downstream of the auxiliary pump 138 exceeds the third pressure.

The control module 135 is configured to receive a setting instruction (not represented) and deduce therefrom a control signal transmitted to the pressure monitoring unit 132. Particularly, the control module 135 is configured to transmit to the pressure monitoring unit 132 a control signal intended to increase the fluid pressure in the first chamber 112 when the setting instruction aims to increase the pitch of the blades 56, and to transmit to the pressure monitoring unit 132 a control signal intended to increase the fluid pressure in the second chamber 114 when the setting instruction aims to reduce the pitch of the blades 56.

The control module 135 is also configured to transmit to the backup circuit 134, more particularly to its auxiliary pump 138, a start instruction in the event of a failure of the pressure generator 130.

The connection system 78 connects the movable part 102 to each blade 56 so as to convert the translation of the movable part 102 along the longitudinal axis X and, where appropriate, the rotation of the movable part 102 about the longitudinal axis X into a rotation of each blade 56 about its pivot axis P. Particularly, the connection system 78 connects the movable part 102 to each blade 56 so as to convert:
the translation of the movable part 102 along the longitudinal axis X in a first direction into a rotation of the variable-setting blade 56 about the pivot axis P towards the web position, and
the translation of the movable part 102 along the longitudinal axis X in a second direction opposite to the first direction into a rotation of the variable-setting blade 56 about the pivot axis P towards the feather position.

For this purpose, the connection system 78 comprises a synchronization crown 140 secured to the movable part 102 and, for each of the blades 56, a mechanism 142 for connecting the blade 56 to the synchronization crown 140.

The synchronization crown 140 extends in a radial plane around the movable part 102. It is particularly fixed to an upstream end 143 of the movable part 102.

Each connection mechanism 142 comprises a first articulation 144 secured to the movable part 102, a second articulation 146 secured to the blade 56, away from the pivot axis P of said blade 56, and a connection member 148 connecting the first articulation 144 to the second articulation 146.

The first articulation 144 is carried by the synchronization crown 140. Here, it is constituted by a ball joint.

The second articulation 146 is also constituted by a ball joint. It is eccentric relative to the pivot axis P.

The connection member 148 has a first end 150 articulated to the first articulation 144 and a second end 152 articulated to the second articulation 146. Advantageously, the connection member 148 is rigid and of adjustable length, that is to say the distance between the first and second ends 150, 152 can be modified, which allows precisely setting its length in the stationary state so as to allow the steering of the setting angle of each blade 56 by the pitch change mechanism 70.

The connection member 148 is here constituted by a connecting rod 153.

In the example represented, each connection mechanism 142 also comprises a crank 154 connecting the attachment piece 60 to the second articulation 146. This crank 154 is rigid and secured to the attachment piece 60. It extends at least partly along a direction orthogonal to the pivot axis P. It forms an arm for rotating the blade 56.

In the example represented, the first direction goes from upstream to downstream, that is to say the movement of the movable member 102 towards its retracted position causes a rotation of each blade 56 towards its web position, and the second direction goes from downstream to upstream, that is to say the movement of the movable member 102 towards its deployed position causes a rotation of each blade 56 towards its feather position. In addition, the first articulation 144 is disposed upstream of the second articulation 146.

For this purpose, the second articulation 146 is, as visible in FIG. 4, placed opposite to the trailing edge 57B relative to a plane Q orthogonal to the chord C and containing the pivot axis P.

As a variant (not represented), the first direction goes from downstream to upstream, the first articulation 144 being disposed downstream of the second articulation 146. The second articulation 146 is then placed on the same side of the trailing edge 57B relative to the plane Q orthogonal to the chord C and containing the pivot axis P.

These particular arrangements allow, when the pitch change mechanism 70 is immobilized, that the natural biasing of the blade 56 towards its web position cause the connection member 148 to work in traction and not in compression. The risk of buckling of the connection member 148 is therefore very low, so that it is possible to use a relatively weak connection member 148 and thus to lighten the pitch change mechanism 70.

The pitch change mechanism 70 also comprises a pitch locking device 160 able to block the translation of the movable part 102 of the control jack 74 in the first direction, that is to say here towards its retracted position.

This locking device 160 comprises a cylindrical surface 162 movable together with the movable part 102 relative to the fixed part 100 and a blocking member 164 for immobilizing the movable part 102 relative to the fixed part 100 by meshing with the cylindrical surface 162.

The cylindrical surface 162 is particularly secured to the movable part 102.

The cylindrical surface 162 is advantageously, as represented, substantially coaxial with the axis X.

In the example represented, the cylindrical surface 162 is carried by an inner cylinder 165 housed inside the cylinder 86.

This inner cylinder 165 is here connected to the movable part 102 by a shroud 166. This shroud 166 here protrudes longitudinally upstream from the control jack 74. It is particularly frustoconical, its diameter decreasing from its downstream end 167 attached to the jack 74, to its upstream end 168 attached to an upstream end 169 of the inner cylinder 165.

In the example represented, the cylindrical surface 162 constitutes an outer face of the inner cylinder 165. As a variant (not represented), the cylindrical surface 162 constitutes an inner face of the inner cylinder 165. Still as a variant (not represented), the cylindrical surface 162 is carried directly by the movable part 102; it typically constitutes an inner or outer surface of the cylinder 104.

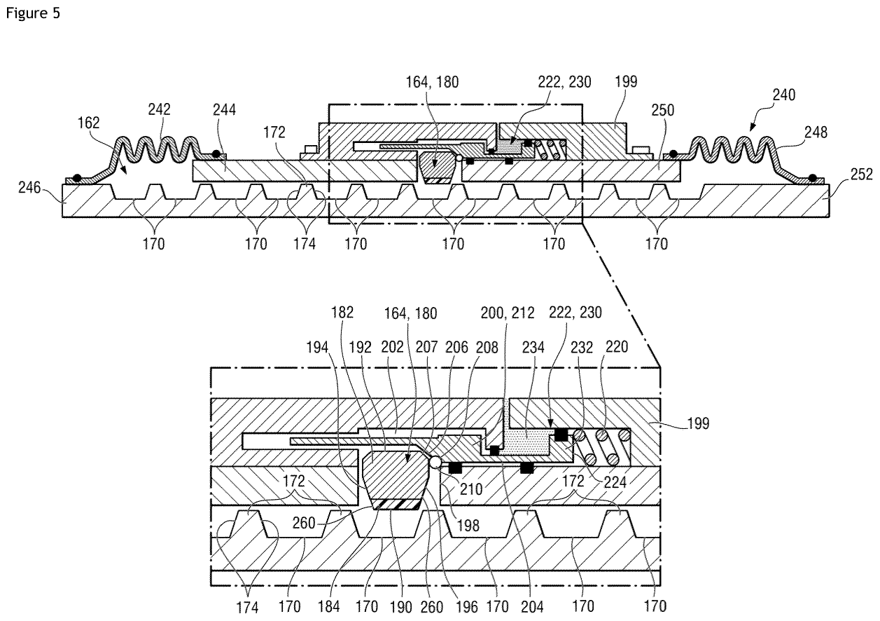

With reference to FIGS. 5 to 8, the cylindrical surface 162 is notched with a plurality of notches 170 each extending orthogonally to the longitudinal axis X.

Advantageously, the notches 170 are formed on the only portion of the cylindrical surface 162 facing the blocking member 164 when the blades 56 are oriented in the large pitches, that is to say when the setting angle of the blades 56 is less than 60°. In other words, the portion of the cylindrical surface 162 facing the blocking member 164 when the blades 56 are oriented in the small pitches or reversely is devoid of notches 170.

The cylindrical surface 162 comprises, for each pair of consecutive notches 170, a rib 172 separating said notches 170. Said rib 172 has inclined flanks 174. These flanks 174 have a maximum inclination, measured relative to the axis X, preferably less than 88°, particularly less than 60°.

Returning to FIG. 3, the blocking member 164 comprises at least one annulus 180 disposed orthogonally to the longitudinal axis X. Said annulus 180 is preferably, as represented, substantially coaxial with the axis X.

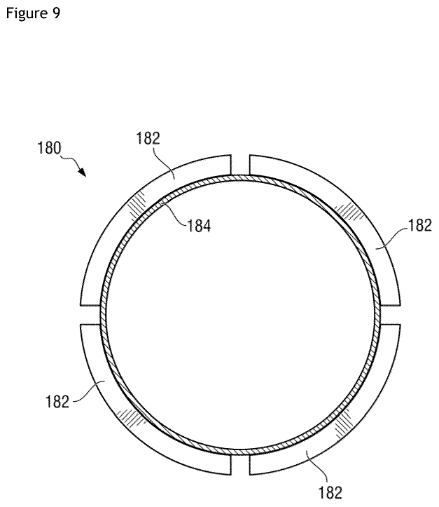

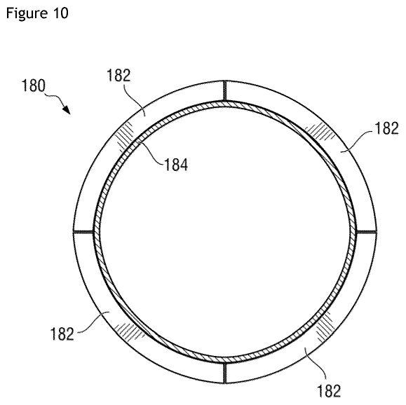

With reference to FIGS. 9 and 10, the annulus 180 is circumferentially divided into several sectors 182 movable with respect to each other between a close configuration, represented in FIG. 10, in which the annulus 180 has a reduced diameter, and a spaced-apart configuration, represented in FIG. 9, in which the annulus 180 has an increased diameter. These sectors 182 are at least two in number. Preferably, their number is greater than or equal to four. In the example represented, the sectors 182 are four in number.

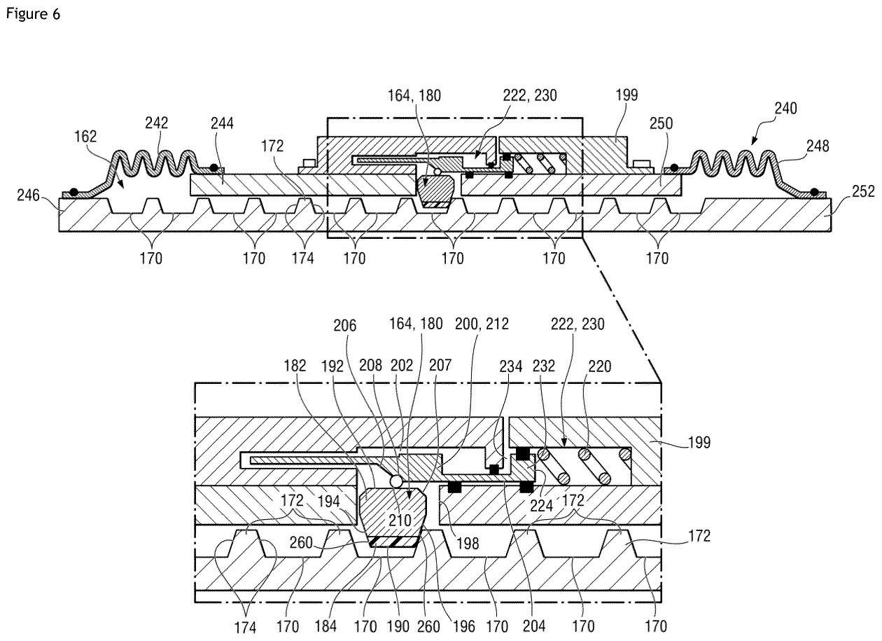

The blocking member 164 thus has an unlocking configuration, represented in FIG. 5, in which the diameter of the annulus 180 is such that the blocking member 164 is away from the cylindrical surface 162, and a locking configuration, represented in FIG. 6, in which the diameter of the annulus 180 is such that the blocking member 164 is meshed with the cylindrical surface 162 by being engaged in at least one of the notches 170.

In the example represented, the blocking member 164 extends, as seen in FIG. 3, around the cylindrical surface 162. The cylindrical surface 162 is therefore interposed between the longitudinal axis X and the blocking member 164. The blocking member 164 is thus in the locking configuration when the sectors 182 of the annulus 180 are in the retracted configuration, and in the unlocking configuration when said sectors 182 are in a spaced-apart configuration. This arrangement is advantageous because it allows the centrifugal force to which the blocking member 164 is subjected when the fan rotor 54 is in rotation to maintain the blocking member in its unlocking configuration.

As a variant (not represented), the cylindrical surface 162 extends around the blocking member 164. The blocking member 164 is then in the locking configuration when the sectors 182 of the annulus 180 are in the spaced-apart configuration, and in the unlocking configuration when said sectors 182 are in the retracted configuration. This is the case, for example, when the cylindrical surface 162 constitutes an inner face of the inner cylinder 165 or of the cylinder 104.

Each sector 182 is rigid. It is typically made of metal.

Returning to FIGS. 9 and 10, the annulus 180 further advantageously comprises a biasing element 184 biasing the sectors 182 towards that of the spaced-apart and close configurations in which the blocking member 164 is in the unlocking configuration. This biasing element 184 is here formed by an elastic annulus, for example an O-ring, delimiting the interior of the annulus 180 and to the outside of which the sectors 182 are added. Thus, the unlocking configuration constitutes the configuration of the blocking member 164 when it is at rest.

Returning to FIGS. 5 and 6, the annulus 180 comprises a first circumferential face 190 oriented radially towards the cylindrical surface 162, a second circumferential face 192 opposite to the first face 190 (and therefore oriented radially opposite to the cylindrical surface 162), a first annular face 194 delimiting the annulus 180 longitudinally upstream and a second annular face 196 delimiting the annulus 180 longitudinally downstream. In the example represented, with the blocking member 164 surrounding the cylindrical surface 162, the first circumferential face 190 constitutes an inner face of the annulus 180 and the second circumferential face 192 constitutes an outer face of the annulus 180. As a variant, when the blocking member 164 is surrounded by the cylindrical surface 162, it is the opposite.

The annulus 180 preferably has, as represented, a longitudinal extension (that is to say between its annular faces 194, 196) smaller than or equal to the longitudinal extension of each notch 170. Thus, when the blocking member 164 is in the locking configuration, the annulus 180 is engaged in only one of the notches 170, which facilitates the design and dimensioning of the locking device 160.

The blocking member 164 is adapted to immobilize the movable part 102 in translation relative to the fixed part 100 when it is in the locking configuration. For this purpose, it is substantially fixed along the longitudinal direction relative to the fixed part 100. It is typically, as represented, at least partially engaged in at least one circumferential groove 198 arranged in a wall 199 of the frame 72. Particularly, the or each annulus 180 forming the blocking member 164 is at least partially engaged in a respective circumferential groove 198 arranged in said wall 199.

The wall 199 is, in the example represented, constituted by the cylinder 86, the rib 198 being arranged in an inner face of the cylinder. According to other variants (not represented):
the wall 199 is formed by a cylinder coaxial with the axis X and surrounded by the inner cylinder 165, the rib 198 being arranged in an outer face of this cylinder; this is typically the case when the cylindrical surface 162 constitutes an inner face of the inner cylinder 165;
the wall 199 delimits at least partly the outer peripheral surface 88 of the frame 72, the rib 198 being arranged in said outer peripheral surface 88; this is typically the case when the cylindrical surface 162 constitutes an inner surface of the cylinder 104;
the wall 199 is formed by an outer cylinder which surrounds the control jack 74, the rib 198 being arranged in an inner face of this outer cylinder; this is typically the case when the cylindrical surface 162 constitutes an outer surface of the cylinder 104.

Still with reference to FIGS. 5 and 6, the locking device 160 also comprises a movable member 200, movable in translation relative to the frame 72 and to the blocking member 164 between a retracted position, represented in FIG. 5, in which it leaves the blocking member 164 free to be in its unlocking configuration and a deployed position, represented in FIG. 6, in which it forces the blocking member 164 into its locking configuration.

For this purpose, the movable member 200 is housed in a space 202 into which the rib 198 opens out opposite to the cylindrical surface 162. It is free to move in translation along the longitudinal direction (that is to say parallel to the longitudinal axis X) inside this space 202. In the example represented, said space 202 is formed by a cavity inside the wall 199.

The movable member 200 has a retaining face 204 able to be in contact with the second face 192 of the annulus 180 when the blocking member 164 is in the locking configuration. For this purpose, this retaining face 204 has a longitudinal extension and delimits in a radial plane a closed contour which has a diameter substantially equal to the diameter of the second face 192 of the annulus 180 in the retracted configuration. Advantageously, it is, as represented, devoid of radial extension. In the retracted position, the retaining face 204 is longitudinally away from said second face 192. In the deployed position, the retaining face 204 and the second face 192 are crossed by the same radial plane; the retaining face 204 thus prevents the blocking member 164 from returning to its unlocking configuration.

The movable member 200 also has a contact face 206 through which it comes into contact with the annulus 180, particularly with a contact edge 207 of the second face 192 of the annulus 180, when it moves from its retracted position to its deployed position. This contact face 206 is located between the annulus 180 and the retaining face 204 when the movable member 200 is in the retracted position. It has a radial extension.

The contact face 206 extends radially from an end edge 208 delimiting a longitudinal end of the retaining face 204. Said end edge 208 thus forms a junction between the contact face 206 and the retaining face 204.

In the example represented, said contact face 206 is beveled, that is to say it has a longitudinal extension, opposite to the retaining face 204, in addition to its radial extension. The force that must be exerted by the movable member 200 on the blocking member 164 to force it into its locking configuration is thus reduced.

In the example represented, the contact face 206 is also provided with a plurality of rollings 210. These rollings 210 are preferably, as represented, distributed circumferentially along the end edge 208. These rollings 210 contribute to reducing the friction between the movable member 200 and the blocking member 164 and therefore to further reducing the force that must be exerted by the movable member 200 on the blocking member 164 to force it into its locking configuration.

As a variant (not represented), the contact face 206 has no rolling 210 or is not beveled.

In the example represented, the movable member 200 comprises a ring 212 carrying the retaining face 204 and the contact face 206. The retaining face 204 is thus cylindrical and the contact face 206 is annular, particularly frustoconical. As a variant (not represented), the retaining face 204 and the contact face 206 are carried by arms protruding longitudinally from a synchronizing ring; the retaining face 204 and the contact face 206 are then each formed of several sections spaced circumferentially from each other.

Still with reference to FIGS. 5 and 6, the locking device 160 further comprises a biasing member 220 biasing the movable member 200 toward its deployed position, and a holding device 222 for holding the movable member 200 in its retracted position under certain predetermined conditions, typically when the third pressure is above a threshold, said threshold being smaller than a minimum supply pressure to the fluid chambers 112, 114 under normal operating conditions. Such a minimum supply pressure to the fluid chambers 112, 114 under normal operating conditions is the minimum pressure provided by the pressure generator 130 in the absence of any malfunction, in particular in the absence of a leak or breakdown.

Thanks to the biasing member 220, the position of the movable member 200 at rest is the deployed position. This allows forcing the blocking member 164 into its locking configuration even in the event of a breakdown.

The biasing member 220 is here constituted by a compression spring compressed between the frame 72 and a shoulder 224 secured to the movable member 200.

The holding device 222 comprises a counterbalancing jack 230 including a counterbalancing piston 232 and a counterbalancing chamber 234.

The counterbalancing piston 232 is movably mounted in translation along the longitudinal axis X relative to the frame 72. It is particularly coaxial with the movable member 200. In the example represented, it is arranged in the longitudinal extension of the movable member 200, between the movable member 200 and the biasing member 220. It delimits particularly the shoulder 224 against which the biasing member 220 bears.

The counterbalancing chamber 234 is delimited between the counterbalancing piston 232 and the frame 72. Particularly, the counterbalancing chamber 234 is delimited between the counterbalancing piston 232 and a wall 236 separating said chamber 234 from the space 200.

The counterbalancing chamber 234 is fluidly connected to the pressure generator 130 by a fluid connection circuit 238 (FIG. 3) so as to be supplied with control fluid at the third pressure. It is intended to counterbalance the biasing of the biasing device 220 when this supply is active.

For this purpose, the counterbalancing jack 230 is arranged so that the pressure exerted on the piston 232 by the fluid contained in the chamber 234 is oriented in a direction opposite to that of the biasing of the biasing device 230. In the example represented, the counterbalancing piston 232 is interposed between the chamber 234 and the shoulder 224 and the shoulder 224 is interposed between the piston 232 and the biasing device 220. In addition, the counterbalancing piston 232 and the counterbalancing chamber 234 are dimensioned so that, when the chamber 234 is supplied with control fluid at a pressure above the threshold, the force exerted by the control fluid on the piston 232 is greater than the biasing of the biasing device 220.

Thus, as long as the pressure provided to the chamber 234 is above the threshold, the biasing of the biasing device 220 is canceled and the movable member 200 is maintained in the retracted position. On the other hand, when the chamber 234 is no longer supplied with control fluid at a pressure above the threshold, typically when the pressure generator 130 breaks down, the force of the biasing device 220 prevails and the movable member 200 is moved into its deployed position.

With reference to FIG. 3, the pressure monitoring unit 132 is here fluidly interposed between the pressure generator 130 and the fluid connection circuit 238. It has a first configuration in which it isolates the fluid connection circuit 238 from the return line 136, and a second configuration in which it fluidly connects the fluid connection circuit 238 to the return line 136.

The pressure monitoring unit 132 is configured to be normally in its first configuration and to switch into its second configuration upon receipt of a control instruction transmitted by the control module 135.

Returning to FIGS. 5 and 6, the locking device 160 finally comprises an elastic sheath 240 between the cylindrical surface 162 and the fixed part 100, particularly between the cylindrical surface 162 and the wall 199. This elastic sheath 240 here comprises an upstream portion 242 connecting an upstream edge 244 of the wall 199 to an upstream edge 246 of the surface 162 and a downstream portion 248 connecting a downstream edge 250 of the wall 199 to a downstream edge 252 of the surface 162. As a variant (not represented), the elastic sheath 240 comprises only the upstream portion 242 or only the downstream portion 248.

The elastic sheath 240 is dust and liquid-tight. It isolates the cylindrical surface 162 from the environment. It is able to elastically deform when the movable part 102 moves relative to the fixed part 100 while maintaining its tightness. Thus, the cylindrical surface 162 is protected from fouling that could fill the notches 170. The maintenance of the locking device 160 is therefore reduced.

As a variant (not represented), the locking device 160 does not comprise the elastic sheath 240. This is in particular the case when the surface 162 is in a space in fluid communication with one of the chambers 112, 114, for example when the upstream guide ring 116 has drillings allowing the control fluid to flow through the upstream guide ring 116 or when the movable part 102 does not comprise an upstream guide ring 116.

In the variant of FIGS. 5 and 6, the flanks 174 of the ribs 172 of the cylindrical surface 162 are straight. The inclination of the flanks 174 is then preferably at least equal to 45°.

In addition, still in this variant, the sectors 182 of the annulus 180 each have a polygonal section. Each sector 182 then comprises two flanks 260 delimiting the sector 182 along the longitudinal direction. In the example represented, these flanks 260 converge towards each other in the direction of the cylindrical surface 162. Advantageously, they are substantially symmetrical with respect to a plane orthogonal to the longitudinal axis X and form therebetween an angle comprised between 4° and 90°, particularly greater than 60°.

Thanks to this inclination of the flanks 174 and to the convergence of the flanks 260, the shear forces supported by the ribs 172 and the blocking member 164 are limited, which allows increasing the service life of the locking device 160. Nevertheless, these inclination and convergence remain sufficiently low to limit the radial forces transmitted to the movable member 200; thus, it is possible to maintain a relatively modest biasing force for the biasing member 220, which allows limiting the size of the counterbalancing chamber 234 and therefore the bulk of the mechanism 70.

Moreover, still in this variant of FIGS. 5 and 6, the contact edge 207 is beveled. This allows further limiting the force that must be exerted by the movable member 200 on the blocking member 164 to force it into its locking configuration. Here again, this contributes to limiting the biasing force of the member 220 and thus also the size of the counterbalancing chamber 234 and therefore the bulk of the mechanism 70.

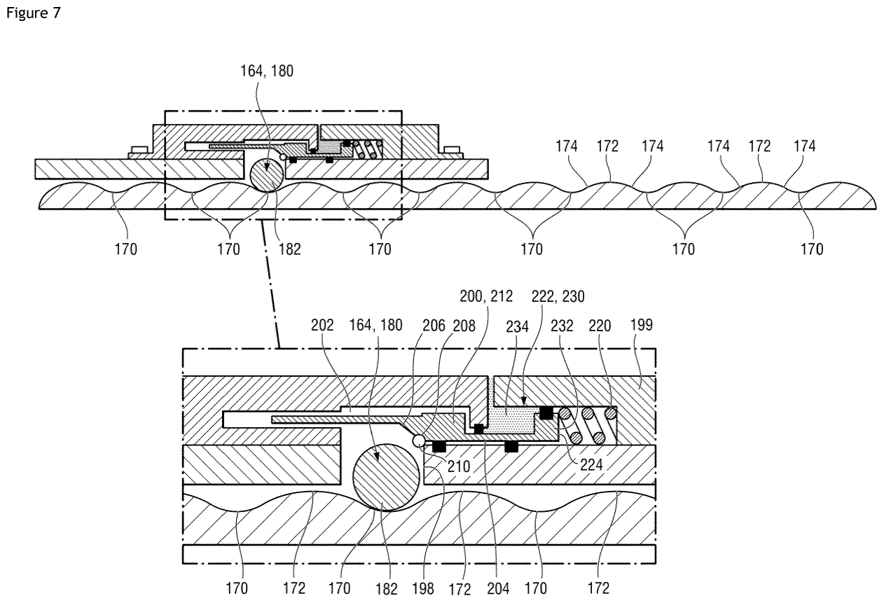

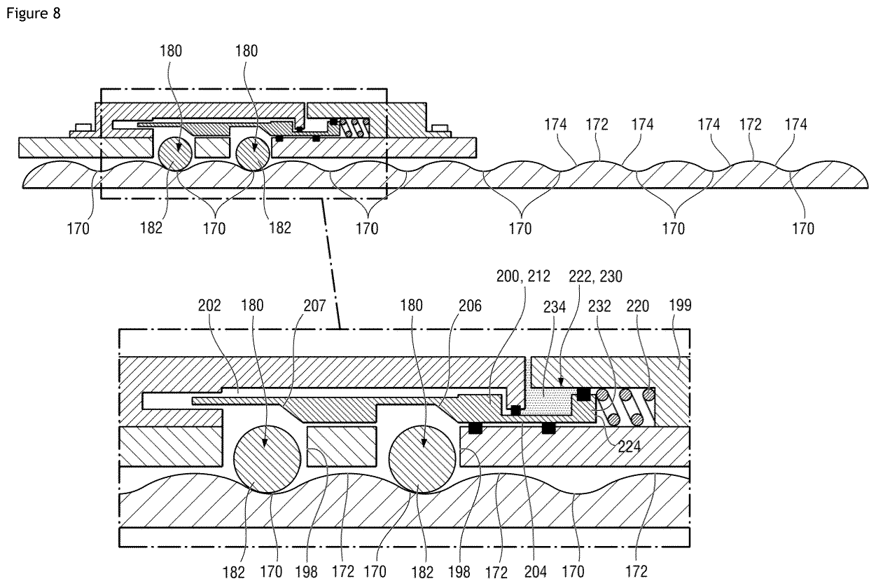

In the variants of FIGS. 7 and 8, the ribs 172 of the cylindrical surface 162 each have a rounded top. In addition, the notches 170 of said surface 162 each have a rounded bottom, the transition from each rib top 172 to each notch bottom 170, via a flank 174 of the rib 172, occurring without any slope break. The cylindrical surface 162 then has a corrugated profile, as seen in the Figures. In this case, the inclination of the flanks 174 of the ribs 172 varies from each notch bottom 170 to each rib top 172 and reaches a maximum at an inflection point substantially halfway between the notch base 170 and the rib top 172; this maximum inclination is advantageously less than 45°.

Moreover, still in these variants of FIGS. 7 and 8, each sector 182 of the or each annulus 180 has a circular or ovoid section.

This allows reducing the friction of the blocking member 164 on the cylindrical surface 162 under normal operating conditions, that is to say when the blocking member 164 is in the unlocking configuration. This is particularly advantageous when the or each annulus 180 is devoid of biasing element 184.

Finally, in the variant of FIG. 8, the blocking member 164 comprises several annuli 180, in this case two. This allows reducing the shear forces supported by the ribs 172 and each annulus 180. The service life of the locking device 160 is thus increased.

The movable member 200 then comprises a retaining surface 204 and a contact surface 206 for each annulus 180.

A method for changing the pitch of the blades 56, implemented by the pitch change mechanism 70, will now be described.

During a first step of this method, the control module 135 first receives a setting instruction aimed at increasing the pitch of the blades 56. The control module 135 then transmits to the pressure monitoring unit 132 a control signal intended to increase the fluid pressure in the first chamber 112. As the fluid pressure in the first chamber 112 increases, the movable part 102 of the jack 74 moves in the second direction, towards its deployed position, which, via the connection system 78, causes the pivoting of the blades 56 towards the large pitches (that is to say towards the feather position).

Under the effect of centrifugal force, possibly coupled with the biasing of the biasing element 184, the blocking member 164 remains in the unlocking configuration away from the cylindrical surface 162 and therefore does not oppose the movement of the movable part 102.

Once the movable part 102 has reached an equilibrium position, it stabilizes, the blades 56 maintaining a fixed orientation.

During a second step of the pitch change method, the control module 135 first receives a setting instruction aiming to reduce the pitch of the blades 56. The control module 135 then transmits to the pressure monitoring unit 132 a control signal intended to increase the fluid pressure in the second chamber 114. As the fluid pressure in the second chamber 114 increases, the movable part 102 of the jack 74 moves in the first direction towards its retracted position, which, via the connection system 78, causes the pivoting of the blades 56 towards the small pitches (that is to say towards the web position).

Under the effect of centrifugal force, possibly coupled to the biasing of the biasing element 184, the blocking member 164 remains in the unlocking configuration away from the cylindrical surface 162 and therefore does not oppose the movement of the movable part 102.

Once the movable part 102 has reached an equilibrium position, it stabilizes, the blades 56 maintaining a fixed orientation.

Optionally, the pitch change method also comprises, following the first or the second step, a step of locking in a controlled manner the orientation of the blades 56.

During this step, the control module 135 transmits a pitch locking command to the pressure monitoring unit 132. Under the effect of this command, the pressure monitoring unit 132 fluidly connects the fluid connection circuit 256 to the return line 136, causing a fluid pressure drop in the counterbalancing chamber 234. The fluid pressure in said chamber 234 then falls below the threshold and is therefore insufficient to counterbalance the biasing of the biasing device 220, which thus causes the deployment of the movable member 200. The latter then presses on the second face 192 of the or each annulus 180, which forces the blocking member 164 to switch into its locking configuration.

If the or each annulus 180 is facing a notch 170 when this deployment occurs, the or each annulus 180 engages in a respective notch 170 and the switching of the blocking member 164 into its locking configuration is complete. The blades 56 are thus blocked in their orientation even in the event of a fluid pressure loss in one of the chambers 112, 114.

If, on the contrary, at least one annulus 180 is facing a rib 172 when this deployment occurs, this rib 172 prevents the blocking member 164 from fully meshing with the cylindrical surface 162 and the switching of the blocking member 164 into its locking configuration is complete. The blades 56 are then not blocked in their orientation in the event of a fluid pressure loss in one of the chambers 112, 114. However, if such a fluid pressure loss occurs, it will cause the movement of the cylindrical surface 162 until a notch 170 is facing the or each annulus 180; the switching of the blocking member 164 into its locking configuration being then no longer held back by the presence of a rib 172, it will be completed, immobilizing the blades 56. Thus, the pivoting of the blades 56 in the event of a fluid pressure loss remains limited.

In the event of a malfunction of the steering system 76, typically in the event of a breakdown of the pressure generator 130, the pitch change method comprises an additional step of locking in an uncontrolled manner the orientation of the blades 56.

During this step, the malfunction of the steering system 76 results in a fluid pressure drop in the counterbalancing chamber 234, typically because the pressure generator 130 is no longer able to raise the third pressure beyond the threshold. The fluid pressure in said chamber 234 is then insufficient to counterbalance the biasing of the biasing device 220, which thus causes the deployment of the movable member 200. The latter then presses on the second face 192 of the or each annulus 180, which forces the blocking member 164 to switch into its locking configuration.

It will be noted that, in this case, the or each annulus 180 is almost systematically facing a notch 170 when this deployment occurs. Indeed, the pressure loss in the chamber 234 is then almost always accompanied by a pressure loss in at least one of the chambers 112, 114 and therefore by the movement of the cylindrical surface 162 with respect to the blocking member 164. The or each annulus 180 therefore engages in a respective notch 170 and the switching of the blocking member 164 into its locking configuration is complete. The blades 56 are thus blocked in their orientation. Particularly, the pivoting of the blades 56 toward the small pitches is then prevented by the locking device 160.

The uncontrolled locking step is followed by a step of securing the fan 50. During this step, the backup circuit 134 is activated and supplies the first fluid chamber 112 and the counterbalancing chamber 234 with control fluid so as to increase the fluid pressure in these chambers. Under the effect of pressure increase in the chamber 234, the movable member 200 retracts and the blocking member 164 returns to the unlocking configuration. The movable part 102 is therefore no longer immobilized and can move downstream under the effect of the pressure increase in the first fluid chamber 112 until the blades 56 are in the feather position.

It should be noted that these different steps can be implemented independently of each other.

Thus, thanks to the exemplary embodiments described above, it is possible, in a simple and robust manner, to lock the current orientation of the blades 56 (with a certain tolerance). This locking is made possible even in the absence of supply energy of the jack 74 and even with a small force, but nevertheless withstands very high loads. And this locking is allowed without significantly increasing the bulk of the mechanism 70.

It will be noted that, although the description above was given for the embodiment in which the cylindrical surface 162 is movable together with the movable part 102 relative to the fixed part 100, the invention is in no way limited to this embodiment alone. Thus, in another embodiment (not represented), it is the blocking member 164 that is movable together with the movable part 102 relative to the fixed part 100, the cylindrical surface 162 then being secured to the fixed part 100.

1. A fan rotor for a turbomachine, the fan rotor comprising:
a hub;
a plurality of variable-setting blades each pivotable relative to the hub about a respective pivot axis; and
an actuator that adjusts an angular position of each of the plurality of variable-setting blades about the respective pivot axis
wherein the actuator comprises:
a control jack including a fixed part fixed relative to the respective pivot axis and a movable part movable in translation along a longitudinal axis relative to the fixed part, the fixed part and the movable part delimiting therebetween two fluid chambers arranged such that an increase of fluid pressure in one of the two fluid chambers relative to a fluid pressure in the other of the two fluid chambers causes the movable part to move relative to the fixed part,
a connection system connecting the movable part to the variable-setting blade so as to convert the translation of the movable part along the longitudinal axis into a rotation of the variable-setting blade about the respective pivot axis, and
a locking device configured to block the translation of the movable part relative to the fixed part in at least one direction,
wherein the locking device comprises:
a surface secured to the fixed part or movable together with the movable part relative to the fixed part, the surface being notched with a plurality of notches each extending orthogonally to the longitudinal axis,
a blocking member having an unlocking configuration away from the surface and a locking configuration meshed with the surface so that the movable part is immobilized in translation relative to the fixed part, in which the blocking member is engaged in at least one of said plurality of notches,
a movable member movable in translation relative to the blocking member between a retracted position in which it the movable member leaves the blocking member free to be in the unlocking configuration and a deployed position in which the movable member forces the blocking member into the locking configuration,
a biasing member that biases the movable member towards the deployed position, and
a holding device that holds the movable member in the retracted position under certain predetermined conditions, the predetermined conditions consisting of a supply pressure to the fluid chambers being above a threshold.

2. The fan rotor according to claim 1, wherein the surface comprises, for each pair of consecutive notches, a rib separating said notches, said rib having inclined flanks.

3. The fan rotor according to claim 2, wherein the rib has a rounded top.

4. The fan rotor according to claim 2, wherein each notch has a rounded bottom, transition from a rib top to a notch bottom, via a rib flank, occurring without any slope break.

5. The fan rotor according to claim 1, wherein the blocking member comprises at least one annulus disposed orthogonally to the longitudinal axis, said annulus being circumferentially divided into several sectors movable with respect to each other between a close configuration in which the annulus has a reduced diameter, and a spaced-apart configuration in which the annulus has an increased diameter, the blocking member being in the locking configuration when the annulus is in one configuration of the spaced-apart configuration and the close configuration and in the unlocking configuration when the annulus is in the other configuration of the spaced-apart configuration and the close configurations.

6. The fan rotor according to claim 5, wherein the at least one annulus is, in the locking configuration, engaged in only one of the notches of the surface.

7. The fan rotor according to claim 5, wherein each sector has a circular section or an ovoid section.

8. The fan rotor according to claim 1, wherein the blocking member has a first face oriented towards the surface and a second face opposite to the first face, and the movable member comprises a retaining face configured to be in contact with the second face of the blocking member in the locking configuration.

9. The fan rotor according to claim 1, wherein the movable member has at least one contact face through which it the movable member comes into contact with the blocking member when the movable member moves from the retracted position to the deployed position, said contact face being beveled and/or provided with at least one rolling.

10. The fan rotor according to claim 1, wherein the surface is cylindrical and the blocking member extends around said surface.

11. The fan rotor according to claim 1, wherein the surface is movable together with the movable part, the blocking member being substantially fixed along the longitudinal axis relative to the fixed part.

12. The fan rotor according to claim 1, wherein the threshold is less than a minimum supply pressure to the two fluid chambers under normal operating conditions.

13. A turbomachine comprising the fan rotor according to claim 1.

14. An aircraft comprising the turbomachine according to claim 13.
